(19) United States
(12) Patent Application Publication
(10) Pub. No.: US 2007/0259307 A1
(43) Pub. Date: Nov. 8, 2007

(54) INSTRUMENTS HAVING ANTI-MICROBIAL COATING

(75) Inventors: Christopher Quan, North Hills, CA (US); Kenneth Rosenblood, Los Angeles, CA (US)

Correspondence Address: DISCUS DENTAL IMPRESSIONS, INC., 8550 HIGUERA STREET, CULVER CITY, CA, 90232, US

(73) Assignee: DISCUS DENTAL IMPRESSIONS, INC., Culver City, CA (US)

(21) Appl. No.: 11/688,858

(22) Filed: Mar. 20, 2007

Related U.S. Application Data
(60) Provisional application No. 60/797,284, filed on May 3, 2006.

(51) Int. Cl. A61C 3/00

(52) U.S. Cl. 433/25; 427/2.29

(57) ABSTRACT

The present invention relates to dental instruments including dental burs, dental discs, tapes, endodontic files, surgical drills and taps, scalers, mirrors, intra-oral light sources, handpieces, perioscopes, covers for dental instruments and other tools having anti-microbial and/or medicament coatings which may be in a substantially permanent covalent manner or in a substantially non-permanent manner. The anti-microbial coating may be made from a variety of anti-microbial substances and other appropriate constituents to promote its fixing to the surface of the dental instrument and to promote its anti-microbial activity either during use or during storage. The substrate of the instruments may also include sources of anti-microbial agents, either by embedding, filling or mixing into the substrate.

### CROSS-REFERENCE TO RELATED APPLICATIONS

This application claims the benefit of U.S. provisional patent application Ser. No. 60/797,284, filed May 3, 2006, entitled “Instruments Having Anti-microbial Coating”; the contents of which are hereby incorporated by reference in their entirety.

### FIELD OF THE INVENTION

This invention relates to dental instruments in general. Specifically, this invention relates to dental instruments having a coating, such as an antimicrobial coating.

### BACKGROUND OF THE INVENTION

Dental practitioners use dental tools (instruments) for dental treatments and procedures, such as dental cleaning and scaling, periodontal treatments, dental restoration, root canal therapy, dental surgery, dental screening, or similar. These instruments are generally re-usable, and hence are cleaned and sterilized after each patient.

There are many ways in the art for cleaning the instruments after use, for example, chemical sterilization or autoclaving. Such processes are typically harsh because high temperatures or strong chemicals are normally needed.

There remains a need for a coating that may aid in the sterilization process and/or that may reduce the chance of contamination between sterilizations or during the use of the instruments.

### SUMMARY OF THE INVENTION

The present invention relates to dental instruments having coatings capable of eliminating, preventing, retarding or minimizing the growth of microbes, thus minimizing the use of high temperature autoclaving process or harsh chemicals and may increase the kind and number of materials useful as substrates for making such tools or instruments. These coatings may also improve the durability and increase the useful life of an instrument or tool.

The coatings may include chemical anti-microbial materials or compounds that are capable of being substantially permanently bonded, at least for a period such as the useful life of an instrument or tool, or maintain their anti-microbial effects when coated with the aid of coating agents, onto the exposed surfaces of dental instruments or tools. In one example, the chemicals may be deposited on the surface of an instrument or tool by covalent linkage.

In other embodiments, the coatings may include chemical antimicrobial materials or compounds that may be deposited in a non-permanent manner such that they may dissolve, leach or otherwise deliver antimicrobial substances to a useful field, such as the mouth, during use.

In still other embodiments, the coatings may include sources of anti-microbial agents which may leach and/or release agents in a moist environment or upon contact with moisture. These sources may be incorporated into the substrate materials used for manufacturing the instruments, or included in the coatings coated on the exposed surfaces of the dental instruments, including working portions and non-working portions such as handles. Incorporation of the sources is especially suited to polymeric substrates.

Chemical antimicrobial materials or compounds may include a variety of substances including, but not limited to antibiotics, antimycotics, general antimicrobial agents, metal ion generating materials, or any other materials capable of generating an antimicrobial effect. Chemical antimicrobial materials or compounds may also be selected to, for example, minimize any adverse effects or discomfort to the patient.

In one embodiment of the present invention, there are disclosed dental instruments used in tooth restoration and replacement, including dental burs, dental discs, tapes and others having abrading working surfaces coated or embedded with diamond particles or chips onto the substrate or shank, the abrading surfaces being coated with an antimicrobial coating that may eliminate, prevent, or minimize the growth of microbes. The shank or substrate may be made of a relatively hard and/or a relatively flexible substrate, and the diamond particles or chips may be coated onto or embedded into the shank or substrate through the use of polymeric bonding agents, through embedding in a nickel or nickel alloy matrix, through chemical vapor deposition or combinations thereof. The anti-microbial material may be coated onto abrading surfaces by means of a coating agent.

In another embodiment of the invention, the abrading surfaces of rotary dental burs, discs, tapes, surgical drills, surgical knives, endodontic files and taps include cutting surfaces formed on the working surface portion of the shank or substrate. The cutting surfaces may have anti-microbial coatings. The surfaces may be treated to more readily and permanently accept the anti-microbial coating. The coating may be present on the cutting surfaces of the instruments or on all of the exposed surfaces.

In yet another exemplary embodiment of the present invention, an ultrasonic dental insert including a proximal end, and a distal end having a tip attached thereto, said tip including a substrate shank, and said insert having an anti-microbial coating coated onto exposed surfaces. Similar to above, the surfaces may be treated to more readily and permanently accept the anti-microbial coating.

In addition to the above, the tip may also be present on other vibratory instruments including an instrument having at least one vibrator module positioned inside the housing of the instrument towards. The module has a small motor adapted to rotate an eccentric weight to cause a vibration in the tip. A battery is positioned inside the housing to power the vibrator module to excite the vibratory element. The battery may be disposable or rechargeable.

In yet a further exemplary embodiment of the present invention, a dental tool including a handpiece, an intraoral light source such as a curing light, a probe, a perioscope, a mirror and other visual aids used in dental treatment or diagnostic procedure is disclosed, said exposed tool surfaces having an anti-microbial coating.

In still yet another exemplary embodiment of the present invention, a cover for any dental tools, such as a sleeve or a sheath for either the grasping portion or the working portion, may also have an anti-microbial coating on the exposed surface or surfaces.

The present invention also includes a dental instrument including a substrate having exposed surfaces and a coating including at least one anti-microbial compound, a medicament, or mixtures thereof, coated onto at least portions of the exposed surfaces in a substantially non-permanent manner whereby such coating may dissolve, leach or deliver antimicrobial substances to an affected area.

The anti-microbial compound may include antibiotics; quaternary ammonium cations; a source of metal ions, triclosan; chlorhexidine; or mixtures thereof.

The medicament may include sensitivity relief agents.

The dental instrument may include rotary dental burs, dental discs, tapes, endodontic files, dental scalers, dental tips, surgical knives, toothbrushes, oral implants, dental trays, surgical drills and taps.

The dental instrument includes a working portion and a non-working portion, both having exposed surfaces, said working portion surfaces are coated with ant-microbial compound in a substantially non-permanent manner and said non-working surfaces are coated with an anti-microbial compound in a substantially permanent fashion.

### BRIEF DESCRIPTION OF THE FIGURES

FIG. 1 shows an exemplary embodiment of a rotary dental instrument having an anti-microbial coating;

FIG. 2 shows an example of a diamond bur having an exemplary coating of the present invention;

FIGS. 2a-f are examples of various shapes and grit sizes of diamond burs having exemplary coatings of the present invention;

FIGS. 3a and 3b are examples of carbide burs having exemplary coatings of the present invention;

FIG. 4 shows an exemplary abrading disc having an exemplary coating of the present invention;

FIG. 5 shows an exemplary abrading tape having an exemplary coating of the present invention;

FIGS. 6a and 6b show an exemplary endodontic file having an exemplary coating of the present invention;

FIGS. 6c and 6d show other embodiments of endodontic files;

FIG. 7 shows an exemplary dental drill having an exemplary coating of the present invention;

FIG. 8 shows a dental mirror having an exemplary coating of the present invention;

FIG. 9 is a top view of a dental tool insert having a tip in an exemplary embodiment of the present invention;

FIG. 9a shows the dental insert of FIG. 9 with a handpiece;

FIG. 10 illustrates an active dental instrument according to one embodiment of the invention;

FIG. 11 illustrates a dental insert having a polymeric hand grip in an exemplary embodiment of the present invention;

FIG. 12 illustrates a dental handpiece having in one embodiment of the invention;

FIG. 12a illustrates a dental handpiece having a hand grip in the form of a pistol grip;

FIG. 12b illustrates a dental handpiece having a detachable sheath;

FIG. 13 illustrates an exemplary perioscope having exemplary coatings of the present invention;

FIG. 14 illustrates a dental surgical knife having an exemplary coating of the present invention;

FIG. 15 illustrates a dental curing light having an exemplary coating of the present invention.

### DETAILED DESCRIPTION OF THE INVENTION

The detailed description set forth below in connection with the appended drawings is intended as a description of the presently exemplified embodiments of dental instruments or tools in accordance with the present invention, and is not intended to represent the only forms in which the present invention may be constructed or utilized. The description sets forth the features and the steps for constructing and using the dental tools or instruments of the present invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

Dental professionals as used herein include dentists, dental hygienists, dental laboratory technicians and others involved in the dental restorative or cleaning processes.

Some of these instruments are developed to aid dental professionals in removing damaged portions of the tooth, including root canals, reconstructing and shaping the restored tooth or replacement tooth, including dental implants. Other instruments include those developed to aid dental professionals in teeth cleaning, plaque removal and other periodontal processes. Still others are developed to aid the dental professional in diagnosis, such as perioscopes, mirrors and other visual aids.

Dental instruments as used herein include ultrasonic dental tools, other vibratory dental tools, rotary instruments, abrading instruments, and other cutting tools for surgical placements of dental and orthopedic implants, including dental scalers, toothbrush, dental implants, dental trays, vibratory scalers, ultrasonic dental scalers, periscopes and mirrors, or other visual aids; rotary dental burs such as dental multi-use diamond burs, dental carbide burs, dental sintered diamond burs, and dental steel burs; dental diamond discs; dental laboratory tungsten carbide cutters; endodontic files; surgical drills, taps and surgical knives, and intraoral light sources such as curing lights. These instruments are all contemplated in the present invention. In addition, as mentioned before, any cover, such as sleeves and sheaths for any of the above mentioned instruments or tools, are also contemplated in the present invention as dental instruments.

During use, the tip and other components of the dental instrument, including the handpiece, may be exposed to various sources of biological contaminants, such as microbes, that may be harmful to the patient. Microbial contamination of the dental instrument may result in the transferal of microbes to the patient or it may also result in the cross-contamination between patients if proper precautions are not taken.

After each use, these instruments are generally re-used after cleaning such as autoclaving and/or chemical sterilization. Some sterilization methods may also be insufficient to effectively eliminate such contamination and which may, in the case of reusable tools and instruments, result in the transferal of contaminants from one patient to another.

As noted above, these cleaning processes are generally harsh, to retard microbial growth or the transfer of microbes from one patient to another. Such cleaning processes also may decrease the useful life of the instruments since the autoclaving or chemical sterilization may affect the coating by attacking the bonding agents or the underline substrate, the electrical circuits, or other components. The anti-microbial coatings and/or its incorporation into substrates for the dental instruments may not only help in the sterilization process so that less rigorous routines can be used, but may also help to keep the instruments sterile during storage and possibly during use.

The present invention provides an anti-microbial coating to the exposed surfaces of any tool or instrument so that harsh temperatures or chemicals generally used in autoclaving or sterilization may not be needed to retard, prevent, or decrease the growth of microbes, and more moderate cleaning may be sufficient to keep the spread or growth of microbes. The substrates used may also affect the coating method used for the anti-microbial coating.

In one embodiment, composite resins or ceramic restoratives are commonly used, whether the restorative work is preformed for aesthetic and/or functional reasons. Since these ceramics are generally as hard as porcelain when they are ready to be sculpted, rotary dental tools such as diamond coated burs or carbide burs are generally used for such sculpting, as well as abrading discs and tapes. The working surfaces are usually coated or embedded with abrasive particles such as diamond chips or crystals. For these instruments, a generally soft substrate is used. When the substrate erodes, the diamond crystals are lost and the bur can no longer perform its function. These tools thus then to wear out quite quickly and have to be replaced. Both the removal and shaping processes in this restoration process contribute to the wear of the instruments. Since the removal process takes longer with moderate pressure, more wear is done on the instruments than the shaping process which takes less time with lighter pressure. The sterilization procedures rival the use process in dulling the instruments, sometimes more than the due to the long cycle time in the autoclave. Any coating that may minimize or retard the growth of microbes on the instrument surfaces may aid in the cleaning process so that harsh conditions or chemical may not be needed is beneficial and may improve the useful life of the instrument. These coatings may also retard the eroding of the substrate. In addition to being coated, for example, anti-microbial materials or sources may also be incorporated into the embedding layer.

In a further embodiment, endodontic files, reamers and similar, are used in root canal procedures. Each file instrument includes a working portion and a non-working shank portion. Depending on the configuration, the working portion may be longer or shorter than the non-working portion. Nevertheless, both portions can potentially come into contact or be exposed to various sources of biological contaminants. Like the dental burrs, these instruments have cutting surfaces, some with intricate surfaces such as helical grooves and cutting edges which can be especially difficult to sterilize, and harsh sterilization conditions are generally used. Any coating that may minimize or retard the growth of microbes on the instrument surfaces may aid in the cleaning process so that harsh conditions or chemical may not be needed is beneficial and may also improve the useful life of the instrument. In addition to being coated, for example, anti-microbial materials or sources may also be incorporated into the substrate of the instruments.

In another embodiment, a dental tool also includes those useful for teeth cleaning, plaque removal and other periodontal processes, as mentioned above, such as an ultrasonic dental tool. These instruments may be coated with anti-microbial coatings of the present invention. The substrates for the tools or instruments may be any material including a polymer, a polymeric alloy, a filled polymer or alloy, a metal, a metallic alloy, and combinations thereof. For the polymeric substrates and some metal substrates, anti-microbial materials or sources may also be incorporated into the substrates.

In still further embodiments, other instruments that may not involved in cutting or scarping, such as those listed above, may also benefit from an anti-microbial coating.

The surface may include various coatings and/or treatments that may facilitate its cleaning, functions, application of a medicament, and/or help maintain sterility during use and storage. For example, the surface may be coated with an antimicrobial composition. Antimicrobial agents may be employed to retard or kill microbes on the surface and in the mouth of the patient by contact and/or deposition of the agent in the mouth of the patient. Antimicrobial agents may include, but are not limited to, antibiotics such as β-lactams (e.g. penicillin), aminoglycosides (e.g. streptomycin) and tetracylcines (e.g. doxycycline), antimycotics such as polyene drugs (e.g. amphotericin B) and imidazole and triazole drugs (e.g. fluconazole), and general antimicrobial agents such as quaternary ammonium cations (e.g. benzalkonium chloride) and compounds such as triclosan. The composition may include a binding agent, an antimicrobial agent and/or other materials conducive to its retention on the dental instrument surface and its use as a sterilizing agent. Suitable binding agents may include, but are not limited to, polymers such as polyethylene oxide (PEO), polylactic acid (PLA) and polyglycolic acid (PGA), polysaccharides such as carrageenan, chondroitin sulfate, ethylcellulose, hydroxypropylcellulose, carboxymethylcellulose, hydroxypropylmethylcellulose and polyvinylpyrrolidone. Other materials in the coating may include flavorants, including sweeteners such as various sugar alcohols (e.g. xylitol), artificial sweeteners (e.g. aspartame) and artificial flavors (e.g. vanillin).

In some embodiments, an antimicrobial coating or a coating of a medicament may be included that may dissolve on contact with the moist environment of the mouth, thus allowing dispersal of the antimicrobial agent or medicament. Water soluble carriers such as hydroxypropylcellulose, polyvinylpyrrolidone or carrageenan may be employed to effect such action. In other embodiments, the antimicrobial agent or medicament may be retained in an insoluble carrier that may linger in the mouth and slowly release the therapeutic. The medicament may include any medicine that may be effective when slowly dissolves or releases. Insoluble high molecular weight carriers, such as PEO, or biodegradable carriers, such as PLA and PGA, may be employed to effect such action.

In other embodiments, to increase the coating efficiency, the surfaces to be coated may be roughened or pitted.

In further embodiments, antimicrobial activity may be built into the surface itself by, for example, covalently bonding antimicrobial agents to the surface of the dental instrument or tool. These covalently bonded materials may act to minimize microbial growth on the surface, either disposable or reusable. In addition, any microbial organisms that may chance to be attached to the material may be killed by interaction with the coating. For example, quaternary ammonium cations, such as N-alkyl-pyridiniums, may be used as antimicrobial moieties in covalently attached polymeric surface coatings. In one case, poly(4-vinyl-N-hexylpyridinium) (N-alkylated-PVP) was previously noted to have an optimum alkyl side chain length for antimicrobial activity. Polyethylenimine (PEI) was also previously used as a bactericidal coating when both N-alkylated on its primary amino group and subsequently N-methylated on its secondary and tertiary amino groups to raise the overall number of cationic quaternary amino groups. Any such covalently bonded quaternary ammonium cation polymeric coatings may be used to give an antimicrobial property to the dental instrument or tool surface.

Antimicrobial coatings may be covalently attached to the surface by a variety of methods and may include, for example, creating suitable reaction sites, such as free hydroxyl or amino groups, by coronal discharge, surface etching, hydrolyzation or other methods that disrupt the surface of the dental instrument to create sites of suitable reactivity. The antimicrobial coatings may then be synthesized by reacting the various precursors with the prepared surface of the dental instrument to build the proper coating. In other cases, silanes may be used as coupling agents to complex antimicrobial moieties to the dental instrument surface. Silanes or other strong affinity coupling agents may be used in particular to bond coatings to metal, glass or polymer surfaces that may resist other forms of attachment.

In yet further embodiments, antimicrobial activity may be achieved by utilizing the antimicrobial properties of various metals, especially transition metals which have little to no effect on humans. Examples may include sources of free silver ions, which are noted for their antimicrobial effects and few biological effects on humans. Metal ion antimicrobial activity may be created by a variety of methods that may include, for example, mixing a source of a metal ion with the material of a dental instrument during manufacture, coating the surface by methods such as plasma deposition, loosely complexing the metal ion source by disrupting the surface of the dental instrument to form affinity or binding sites by methods such as etching or coronal discharge, and depositing a metal onto the surface by means such as electroplating, photoreduction and precipitation. The dental instrument surface may then slowly release free metal ions during use that may produce an antimicrobial effect.

In some embodiments, the source of metal ions may be an ion exchange resin. Ion exchange resins are substances that carry ions in binding sites on the surfaces of the material. Ion exchange resins may be impregnated with particular ion species for which it has a given affinity. The ion exchange resin may be placed in an environment containing different ion species for which it has a generally higher affinity, causing the impregnated ions to leach into the environment, being replaced by the ion species originally present in the environment.

In an exemplary embodiment, a dental instrument may include an ion exchange resin containing a metal ion source, such as, for example, silver. Ion exchange resins containing metal ion sources may include, for example, Alphasan® (Milliken Chemical), which is a zirconium phosphate-based ceramic ion exchange resin containing silver. An ion exchange resin may be coated onto a dental instrument or it may be incorporated into the material of a dental instrument.

In still further embodiments, the dental instrument surface may be coated with a de-sensitizing agent, for example, alkali nitrates such as potassium nitrate, sodium nitrate and lithium nitrate; and other potassium salts such as potassium chloride and potassium bicarbonate. The most often used ones include potassium nitrate.

In other embodiments, the dental instrument may include both antimicrobial agents that are coated onto the surface as a means of dispensing them into the mouth and covalently bonded ones for helping to reduced microbial growth on the dental instrument.

The coating may be present over substantially the entire exposed surfaces of the dental instrument, or it may be present only on the surfaces that come into contact with the mouth. In the embodiments where the coating is only present on the surfaces that come into contact with the mouth, the surfaces may be roughened to hide the material inside the valleys or pits, as noted above.

In some embodiments, a layer of substantially non-permanent coating including an anti-microbial compound may be present on top of a layer of a substantially permanent coating including an anti-microbial compound.

The substantially permanent anti-microbial coating may be, for example, substantially flexible so that the coating covers the working surfaces of the dental tool or instrument during use. If the anti-microbial compound is not capable of forming a substantially flexible coating by itself, then a binding agent capable of forming a substantially flexible coating may be used to aid in the flexibility of the resulting coating.

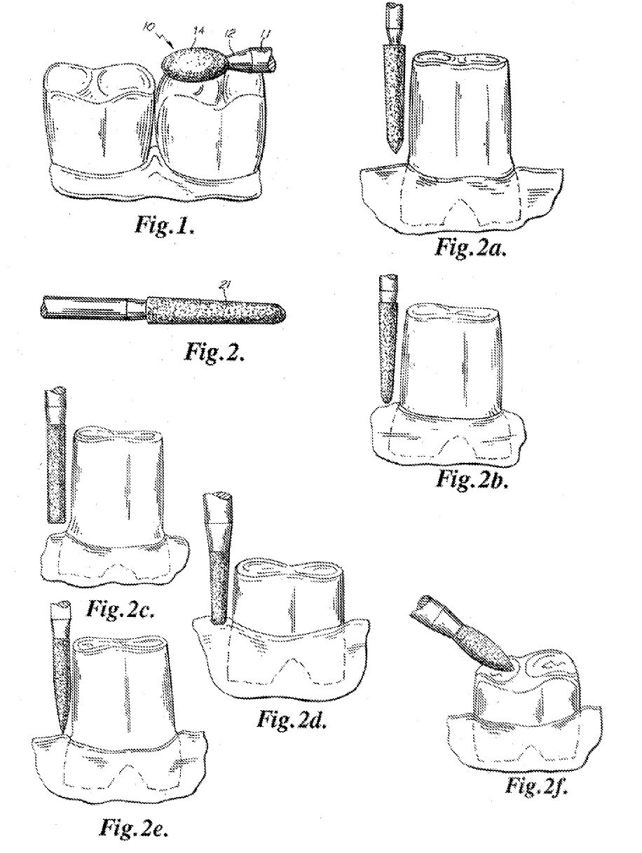

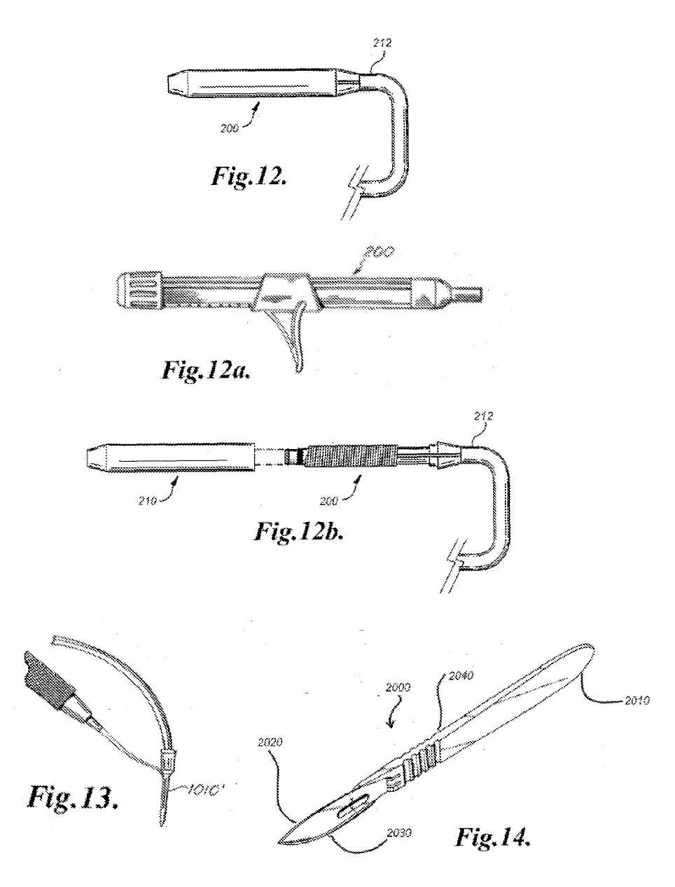

In FIG. 1, an exemplary rotary dental bur is shown. The bur 10 includes a shank 11 having a non-abrading shank portion 12 adapted to be fitted into a dental handpiece, an example of which is shown in FIG. 12, and an abrading working portion 14 connecting to and extending downwardly from the non-abrading shank portion 12. The abrading working portion 14 includes an abrading surface.

One way of generating an abrading surface is by coating or embedding diamond particles 21 into the working surface of working portion 14 of the substrate shank 11. The abrading particles may in turn coated with a durable coating, such as a diamond-like carbon coating, prior to be coated with an ant-microbial coating 22.

Another way of generating an abrading surface is by forming cutting surfaces or edges on the surface of the working portion 20 of the shank 11.

The shank 11 may be made of any suitable metal, including for example, stainless steel, titanium, titanium alloys such as nickel-titanium and titanium-aluminum-vanadium alloys; aluminum, aluminum alloys; tungsten carbide alloys and combinations thereof. More for example, stainless steel and titanium alloys have good flexibility and resistance to torsional breakage.

As an exemplary embodiment, FIG. 2 shows a diamond bur including, for example, a one piece solid stainless steel construction with micro-precise calibration of shank diameters and true concentricity. This instrument may be used to create a rounded gingival margin suited for porcelain fused to metal restoration, as shown in FIG. 2a, or it may be designed for preparing a rounded margin at or below the gingival line with, for example, a 60 degree finish line, as shown in FIG. 2b, ideal for metal or ceramic crowns, for example. Some may also be designed to leave a 90 degree gingival finish line. These generally have a square internal angle and may be tapered or have parallel axial walls, ideal for full porcelain fused to metal restorations, as shown in FIG. 2c. Others may have modified shoulders, designed to leave, for example, a 90 degree gingival finish line with a rounded internal angle, ideal for full porcelain and porcelain fused to metal restorations, as shown in FIG. 2d. FIG. 2e shows an instrument with a tapered axial wall with an extended chamfer finished line, which is most often used for metal margins. Still others are as exemplified in FIG. 2f, for occlusal and lingual reduction, and may be shaped to conform to the occlusal and lingual surfaces with a convex shape, to provide fast bulk reduction and finishing of these surfaces.

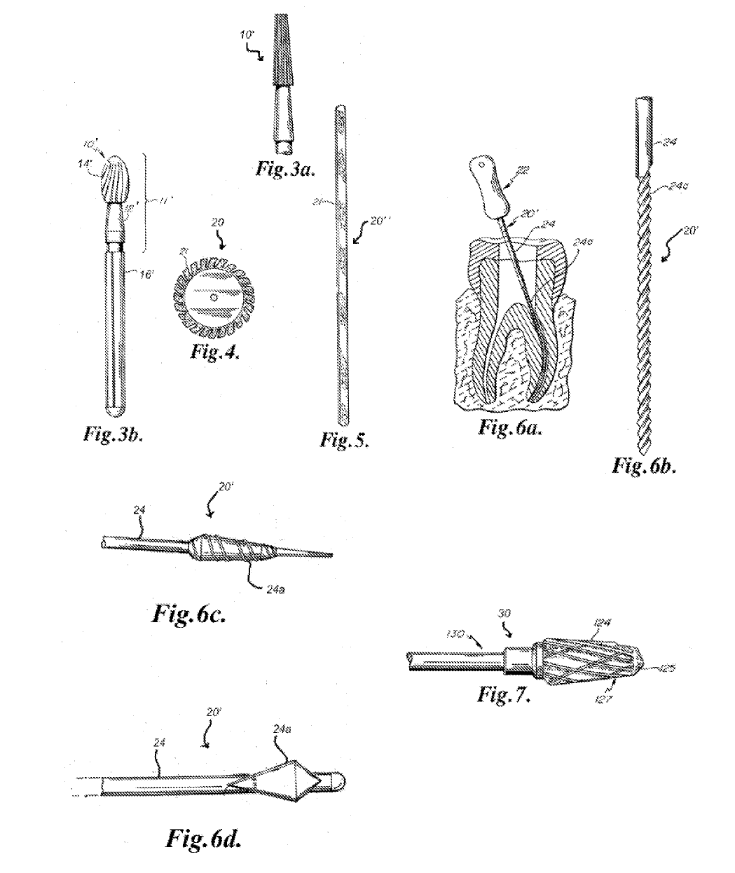

Finishing carbide burs are other examples of rotary burs. Some examples of carbide burs 10′ are shown in FIGS. 3a and 3b. The shank 11 may be made of, for example, a one piece solid tungsten carbide alloy construction with micro-precision calibration of shank diameters. Like diamond burs discussed above, carbide burs 10′ may also be made in many different shapes and blade configurations, with each shape being designed specifically to perform a certain function in trimming, defining and finishing a composite or ceramic restoration of teeth. Finishing carbide burs 10′ may also have substantially perfect concentricity and very sharp blade edges. Unlike diamond burs, these sharp edges promote smooth, vibration-free cutting with light working pressure. Most of them may be used to make final adjustments to porcelain restorations.

FIG. 3b shows an example of a finishing carbide bur 10′ having a “football” or “egg” shape head 14′. This shape is ideal for fine finishing of occlusal surfaces, to remove any striations caused by diamond burs.

An abrading disc 20, as shown in FIG. 4, may include a flexible substrate that may be made of metal or polymer. The surface of the substrate may be coated or embedded with diamond particles or cutting edges 21 formed thereon. The substrate is substantially thin, for example, at less than about 5 mils (about 0.13 mm), more for example, less than about 3 mils (about 0.08 mm), even more for example, less than about 2 mils (about 0.05 mm). The abrading disc 20 may be bent or twisted, for example, up to about 100°, more for example, up to about 180° without damage to the integrity of the substrate and/or coating.

An abrading tape 20″, as shown in FIG. 5, includes a thin flexible substrate that may be made of metal or polymer. The exemplary thicknesses for the substrate are similar to the substrate of the dental abrading disc. The surface of the substrate may be coated or embedded with diamond particles or cutting edges 21. Likewise, the tape 20″ may, for example, be bent or twisted up to 180° without damage to the integrity of the substrate and/or coating.

A suitable metal for the flexible substrate of the disc or tape may be those suitable also for the shanks of dental burs and also include stainless steel, titanium, titanium alloys such as nickel-titanium and titanium-aluminum-vanadium alloys; aluminum, aluminum alloys; tungsten carbide alloys and combinations thereof, for example. More for example, the materials are stainless steel and titanium alloys having good flexibility.

A suitable non-metal may include a polymeric material, such as a high temperature plastic including a polymeric alloy such as ULTEM®, which is an amorphous thermoplastic polyetherimide, Xenoy® resin, which is a composite of polycarbonate and polybutyleneterephthalate, Lexan® plastic, which is a copolymer of polycarbonate and isophthalate terephthalate resorcinol resin (all available from GE Plastics); liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference) or combinations thereof.

In addition, any polymeric composite such as engineering prepregs or composites, which are polymers filled with pigments, carbon particles, silica, glass fibers, conductive particles such as metal particles or conductive polymers, or mixtures thereof may also be used.

Generally, polymeric materials or composites having high temperature resistance are suitable.

When abrasive particles are used, they are, for example, bonded in as close to a single layer as possible, thus exposing more diamond edges. Materials such as diamond particles may be electroplated with nickel or other similar metals, they may be chemical plasma deposited, such as described in U.S. Pat. No. 5,277,940, or they may be embedded in a nickel or nickel alloy matrix, or embedded or bonded using an adherent layer such as a coating of polyurethane or similar hard polymers, as described in U.S. Pat. No. 5,273,559. An exemplary bonding system is one that promotes superior retention of diamond particles on the burs, discs or tapes and minimizes clogging, to result in a faster, cooler cut and a longer lasting diamond instrument.

When an abrading surface is generated by forming various cutting surfaces or edges onto the substrate shank portion 24, the cutting surfaces or edges 24a may include grooves or thin edges, and may be formed either by grinding, casting or molding, or by micro-replication, especially for moldable metals or polymeric substrates, such as shown in FIGS. 6a and 6b.

Endodontic files, reamers and similar, are used in root canal procedures. Each file instrument 20′, such as exemplified in FIGS. 6b, 6c or 6d, includes a working portion 24a and a non-working shank portion 24. Depending on the configuration, the working portion 24a may be longer, as shown in FIG. 6b, or shorter, as shown in FIG. 6c or 6d, than the non-working portion 24. Both portion may potentially come into contact or be exposed to various sources of biological contaminants.

Referring to FIGS. 6a and 6b, there is shown an endodontic file 20′ as it appears inside and outside a root canal. The file includes a handle 22, a shank 24, and a working surface of the shank 24a. The working surface 24a includes cutting edges useful for performing cleaning in a root canal procedure. The working surface 24a may also include abrading particles coated or embedded in the shank as mentioned above. The working surface 24a may additionally be coated with a relatively flexible coating that follows the contour of the working surface for improving the life of the instrument, as noted above. These working surfaces 24a have helical cutting edges which come into direct contact with diseased tooth and tissue. The anti-microbial coating may be present on the substrate or over the flexible coating, if present. The coating may be present on all the exposed surfaces or on the working surfaces 24a only.

Referring to FIG. 6c, the instrument 20′ has a shorter working surface or portion 24a than the instrument as shown in FIG. 6b, but nevertheless has a helical working surface 24a. Likewise, the anti-microbial coating may be present on the substrate or over the flexible coating, if present. The coating may be present on all the exposed surfaces or on the working surfaces 24a only.

In FIG. 6d, the instrument 20′ also has a relatively short working portion or surface 24a, but unlike that of FIGS. 6a, 6b or 6c, the working surface is not helical, but of a configuration having projections, each of the projecting sections does not twist about the longitudinal axis of the shank portion more than 359 degrees. The working surfaces 24a may also be coated with an anti-microbial coating, directly onto the substrate or over a flexible coating, if present.

In some embodiments, the working surface may have a layer of substantially non-permanent coating including an anti-microbial compound present on top of a layer of a substantially permanent coating including an anti-microbial compound.

In other embodiments, a layer of substantially non-permanent coating including an anti-microbial compound may be present on the working surfaces of the instrument while a layer of a substantially permanent coating including an anti-microbial compound may be present on the non-working surfaces of the instrument.

FIG. 7 shows a dental drill 30 having a shank portion 130 and a drill bit portion 127 including cutting edges 124, 125. These cutting edges 124, 125 may be coated with a relatively flexible coating (not shown here) that can follow the contours of the edges. As noted above, the anti-microbial coating may be present on the substrate or over the durable coating, if present. The coating may be present on all the exposed surfaces or on the working surfaces only.

The dental burs, such as diamond burs, are generally configured to be of substantially perfect concentricity in addition to having a good bonding system. They may also be made in a variety of shapes, as noted above, and grit sizes, designed to perform many different techniques on teeth and/or restorations in the restorative process. The grit sizes may include super coarse, coarse, medium, fine, superfine and ultra fine. Each grit size has a different function, from bulk reduction to fine finishing, like sandpaper when used in restoring fine antique furniture. Most dental professionals use anywhere from 6 to 10 different shapes of diamond burs and each also has different preference about the shapes and grit each uses. The dental discs and tapes also have similar functions to burs, and like sandpaper, may also have various grit sizes and shapes. Due to their flexibility, they may be used for hard to reach surfaces such as between teeth.

Wear of the rotary instruments occurs similarly and differently for abrading surfaces formed in different ways. For the abrading surfaces formed by embedding or coating diamond particles on substrates, the substrates may erode during use and cause the particles to become lost, and such loss causes the abrading surfaces to lose their abrading function. Since the abrading surfaces formed by particles are generally rough, the surfaces may be even more difficult to clean than sharp edges. Thus, an anti-microbial coating that retards, eliminates, the, the growth or transfer of microbes may go a long way to helping to clean the difficult to clean instruments.

As mentioned above, dental instruments may also include intraoral light sources including curing lights, cleaning instruments for teeth cleaning, plaque removal and other periodontal processes. The tip may be in the form of a scaler, or those useful for other periodontal treatments including a perioscope, a mirror, and other visualization aid, and handpieces for inserting dental instruments mentioned above.

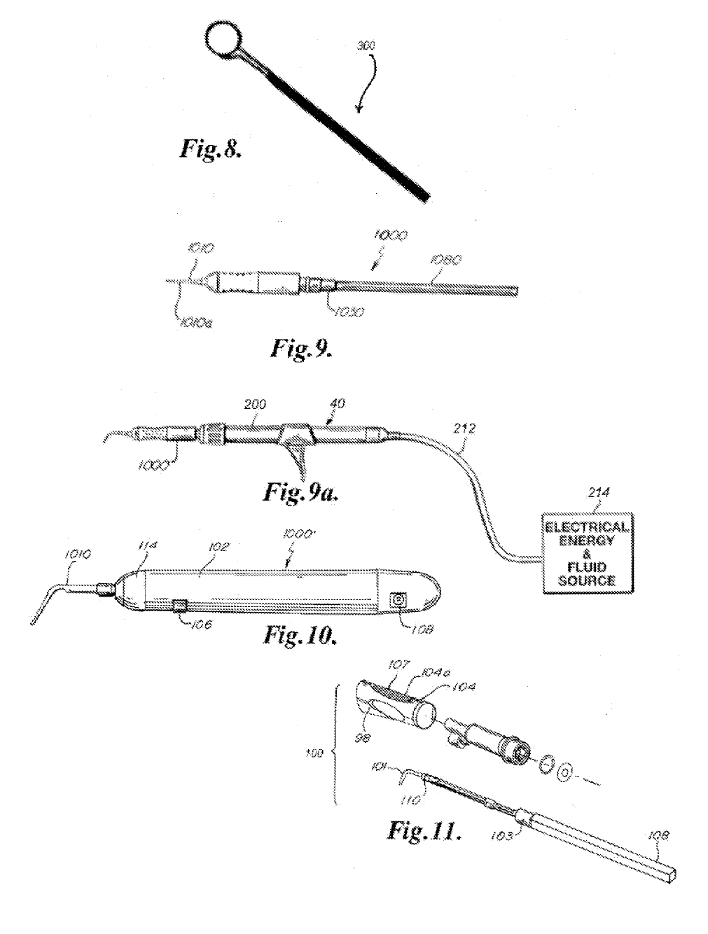

FIG. 8 illustrates a mirror 300 used in dental procedures such as cleaning or scaling. In this embodiment, a substantially transparent coating that does not substantially affect the purpose of the mirror may be used.

FIG. 9 illustrates a dental insert 1000 including a tip 1010 at its distal end and an ultrasonic transducer 1080 at its proximal end. The tip 1010 may be coupled to the transducer 1080 via a connecting body 1030, which may take the form of a shaft. The tip 1010 may be constructed to be removably attached to the connecting body 1030 so that tips may be interchanged depending on the desired application, though more typically, they are permanently attached. Further, the tip 1010, when removed, may be disposed or steam autoclaved, or otherwise sterilized, after detaching it from the rest of the ultrasonic dental insert 1000. If permanently attached, the entire dental insert is sterilized. Coating the entire insert 1000 may be beneficial.

The tip may be made of metal or plastic, and may include the metals, metallic alloys, polymers and polymeric blends and prepregs mentioned above. Some of them may also have a capability of delivering fluid and/or air.

The tool typically may include a handpiece 200 coupled at one end (i.e., a proximal end) to an electrical energy source and a fluid source 214 via a cable 212, as shown in FIG. 9a. The cable 212 includes a hose to provide a fluid (e.g., water), and conductors to provide electrical energy. The other end (i.e., a distal end) of the handpiece 200 has an opening intended to receive a replaceable insert 1000 with a transducer 1080 (e.g., a magnetostrictive transducer or a piezoelectric transducer) carried on the insert 1000. The transducer 1080 extends from the proximal end of the insert 1000 into a hollow interior of the handpiece 200. A tip 1010 extends from a distal end of the insert 1000. Coating of any exposed surfaces or all of the surfaces may be beneficial.

FIG. 10 shows an exemplary embodiment of the instrument 1000′, such as a scaler, of the present invention. A vibratory instrument 1000′ includes a housing having, for example, at least a portion of the housing serving as a handle 102 for grasping by the dental professional. The instrument 1000′ includes a vibrational mechanism located within a handle portion 102 adapted to induce motion of a scaler tip 1010 with respect to the handle 102, or a portion thereof. The motion of the scaler tip 1010 may include a variety of oscillatory modes including flexural and elastic linear modes and torsional modes.

The instrument 1000′ includes a handle portion 102 and a tooth contacting portion 1010. In the illustrated embodiment, the tooth contacting portion 1010 is a scaler tip. According to one aspect of the invention, a vibrational mechanism is included within the handle portion 102. The vibrational mechanism is adapted to induce motion of the scaler tip 1010 with respect to the handle 102, or a portion thereof. The motion of the scaler tip 1010 may include a variety of oscillatory modes including flexural and elastic linear modes and torsional modes. The details of a vibratory instrument is disclosed in a U.S. provisional application No. 60/624,833 entitled, “Dental Instrument” filed on Nov. 3, 2004; and U.S. patent application Ser. No. 11/230,710 entitled, “Dental Instrument”; the contents of both of which are hereby incorporated by reference.

According to one embodiment of the invention, the invention includes a switching device 106 supported by the handle portion 102. The switching device 106 allows a user to activate, and deactivate, the vibrational mechanism disposed within the handle portion 102.

According to one embodiment of the invention, an energy port 108, such as a plug receptacle, may also be supported by the handle portion 102. Energy such as electrical energy, maybe received through the energy port and stored within the handle portion 102 of the dental instrument. In the embodiment shown, the energy port is an electrical plug receptacle adapted to receive a conventional electrical plug.

The dental tip 1010 may be present on both the distal end and the proximal end of the instrument (not shown) or it may present on only one end. Furthermore, the handle portion may be tapered toward either the distal end or the proximal end or both, and extending from the tapered end or ends are the dental tips 1010 adapted to be used on a patient's teeth or tooth.

The tapered portion may be integrally constructed as part of the handle or it may be constructed separately, by either molding, brazing, threadably connected or any other type of attachment to attach the tip 1010 onto either the distal or the proximal end of the handle 102.

The instrument 1000′ may include a cone-shaped portion 114 permanently attached or removably attached to it with its wider end of the cone-shaped portion, and the dental tip 1010 extending from the narrower end of the cone-shaped portion 114. The dental tip 1010 may be permanently attached or removably attached to the narrower end of cone-shape portion 114. The cone-shape portion 114 has at least a partially hollow body. A vibrator module may be positioned and supported inside the hollow portion of the cone-shape portion 114 (not shown).

The module has a small motor for rotating an eccentric weight to cause a vibration in the tip 1010. A battery may be positioned inside the housing to power the vibrator module to excite the vibratory element. The battery may be disposable or rechargeable.

The tapered portion may further be the cone-shaped portion having a hollow interior. The cone-shaped portion may also be rotatable wherein such rotation also rotates the dental tip 1010 so that the tip 1010 may be easily repositioned without being taken out of the patient's mouth. The mechanism for rotation is similar to that described in the patent application U.S. Published Application, US 2004/0126737, entitled, “Ultrasonic Dental Handpiece Having A Rotatable Head, the content of which is incorporated herein by reference.

Some tips 1010 are bent, either slightly or substantially.

As noted above, the instruments or tools mentioned above may have durable coatings for the working surfaces, such as that disclosed in U.S. patent application Ser. No. 11/230,605, entitled “Dental Instruments having Durable Coatings”, filed Sep. 19, 2005, the contents of which are hereby incorporated by reference.

Some inserts 1000 are also made with hand grips to facilitate the gripping of the instruments during use. The hand grip may be made of soft material including a polymeric material for more comfort grip. Some may be made of high temperature resins, which may or may not be soft, suitable for autoclaving or heat sterilization processes. However, even some high temperature resins may not be able to sustain multiple autoclaving processes. Therefore, as mentioned above, an anti-microbial coating having the capability of reducing or diminishing the harsh condition necessary for the autoclaving or sterilization used.

In some embodiments, the inserts 100 may also made with hand grips 104 to facilitate the gripping of the instrument during use, as illustrated in FIG. 11. Such hand grips are generally made of high temperature resin suitable for autoclaving or heat sterilization process, including those polymers and composites described above that are suitable for the construction of the polymeric tips. In fact, any high temperature resin that can withstand autoclaving may be used, though with coatings of the present invention, less demanding action may be used.

The hand grip 104 may be fabricated using thermoplastic elastomers such as SANTOPRENE® available from the Monsanto Company, or those used in the construction of some tips, or any other suitable material, as mentioned before. The hand grip 104 may be formed through injection molding in some embodiments. In other embodiments, the hand grip 104 may be a one-piece hand grip, which is mounted in such a way as to have a surrounding relationship with the connecting body 103, as shown in FIG. 4. In still other embodiments, multi-piece hand grips may be used. By way of an example, a two-piece handgrip may be ultrasonically welded together over the connecting body 103. The hand grip 104 may have a generally cylindrical shape, or may shape like a pistol, as shown in FIGS. 8 and 9a. The handgrip may also be present on the handpiece 200, such as shown in FIG. 12a.

The hand grip 104 may also have a slightly protruding portion 98 on one side at the end of which a light source (e.g., LED) is disposed (not shown). Along its outer surface on the other side of the slightly protruding portion 98, the hand grip 104 has a contour and has a slightly concave area 107, enabling it to be easily grasped by a dental practitioner. The hand grip 104 may also have formed thereon a plurality of bumps 104a (i.e., striped protrusions as shown in FIG. 11) on its external surface to further facilitate grasping of the device by a dental practitioner. Some may even be ergonomically designed. In the described embodiment, a linear groove (e.g., a passageway) 110 is formed on the tip 101 for delivering fluid (e.g., water) and/or air to the gum or tooth of the patient.

The hand grips may also be made with varying diameters for grasping, designed to be used interchangeably throughout the day, coupled with more ergonomically designed handles. The details of varying diameters are described in a U.S. Published Application, US 2006/0063130 entitled, “Dental Instruments with Stress Relief”, the content of which is incorporated herein by reference.

Referring now to FIGS. 12, 12a and 12b, there are shown embodiments of dental handpieces 200. A dental handpiece 200 may in general receive an insert, such as an ultrasonic insert, as described above. Other dental handpieces 200 may also include rotary handpieces which may receive other dental tools, such as, for example, prophy angles, drill bits, burs and/or files. In general, the handpieces 200 may include an antimicrobial coating, as described above.

In some embodiments, the handpiece 200 may include a separable sheath 210, as shown in FIG. 12b. The sheath 210 may incorporate antimicrobial coatings, as described above. The sheath 210 may also be replaceable such that the entire handpiece 200 and its associated components may not have to be replaced along with the sheath 210. This may be desirable where the antimicrobial coatings may have a limited lifetime that may be shorter than the overall lifetime of the dental handpiece 200.

FIG. 13 illustrates an exemplary embodiment of the invention including a perioscope having a metal sheath 1010′ which may be used to slightly retract the gingival tissues away from the tooth, thus providing a direct line-of-sight for the camera to see what is on the subgingival root surface. Users of this scope may generally hold it in one hand for visualization, and may also hold an ultrasonic device in the other hand for cleaning.

FIG. 14 shows an exemplary surgical knife 2000 of the present invention. The knife includes a shank 2040 with a distal end 2020, a proximal end 2010, and a cutting portion 2030.

The shank may be made of a non-metal, including the materials mentioned above for the construction of other shanks, or a metal. A suitable metal may include those mentioned above in relation to the shanks also. The more desirable materials are stainless steel, titanium alloys, and similar.

In general, the metal tips 1010 may be used for general cleaning, scaling and the like, while the non-metal tips 1010 may be used around sensitive gum lines, on expensive restorations such as crowns, bridges, and/or around titanium implants which may be more easily damaged by a metal tip 1010.

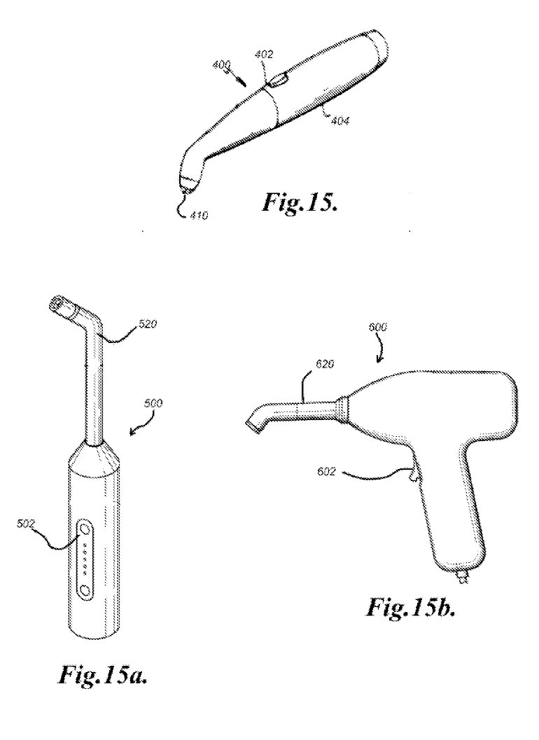

FIGS. 15, 15a and 15b show embodiments of curing lights with or without a light transport or light guide attachment. A curing light 400 may generally include at least one light source 410, a control feature 402 and a body 404, as shown in FIG. 15. The curing light may also include a light guide or transport attachment 520, as shown on curing light 500 in FIG. 15a. A curing light may be generally in the form of a pen, such as in FIGS. 15 and 15a, or a curing light may be in the form of a gun, such as shown with curing light 600 in FIG. 15b. The curing light 600 may also feature a light guide or transport attachment 620. The exposed surfaces of the curing lights may be coated with an antimicrobial coating, whether the surface is inside or outside of a patient's oral cavity during use. In particular, the light guides 520, 620 or the light source 410 may be coated.

The embodiments described above are intended to be illustrative and not limiting. It will be appreciated by those of ordinary skill in the art that other embodiments of the present invention are possible without departing from the spirit or essential character of the invention hereof. The scope of the present invention is indicated by the appended claims, and all changes that come within the meaning and range of equivalents thereof are intended to be embraced therein.

1. A dental instrument comprising a substrate having exposed surfaces, and an anti-microbial coating covalently bonded to at least a portion of the exposed surfaces of the substrate for inhibiting or retarding the growth of microbes on said surfaces.

2. The dental instrument of claim 1 wherein said instrument is selected from the group consisting of rotary dental burs, dental discs, tapes, endodontic files, dental scalers, vibratory scalers, dental tips, surgical knives, mirrors, probes, perioscopes, intra-oral light sources, dental trays, dental implants, handpieces, covers for dental instruments, surgical drills and taps.

3. The dental instrument of claim 1 further comprising a temporary anti-microbial coating on at least a portion of the exposed surfaces.

4. The dental instrument of claim 1 wherein said anti-microbial coating comprises an anti-microbial compound and at least one coating agent for binding the ant-microbial compound onto the surface of the instrument.

5. The dental instrument of claim 1 wherein said anti-microbial coating comprises quaternary ammonium cations.

6. The dental instrument of claim 5 wherein said quartenary ammonium cations comprises N-alkyl-pyridinium, poly(4-vinyl-N-alkylpyridinium), N-alkylated-polyethylenimine, or mixtures thereof.

7. The dental instrument of claim 5 wherein said anti-microbial coating comprises a compound having an alkyl side chain length of about 0 to about 12 carbons.

8. The dental instrument of claim 5 wherein said anti-microbial coating comprises a compound having an alkyl side chain length of from about 5 to about 7 carbons.

9. The dental instrument of claim 1 wherein the anti-microbial coating is a substantially flexible coating.

10. The dental instrument of claim 2 wherein the tip comprises a part of an ultrasonic dental insert or a vibratory instrument, said tip comprises the antimicrobial coating.

11. The dental tip of claim 10 wherein said cover is adapted for covering the dental handpiece.

12. An endodontic dental instrument having exposed surfaces on a working portion and a non-working portion, said instrument having an anti-microbial coating coated thereon at least a portion of said exposed surfaces, wherein said anti-microbial coating comprises an anti-microbial compound covalently bonded to the surface of the instrument, an anti-microbial compound adapted for release into the oral cavity, a source of anti-microbial metal ions, or an anti-microbial compound and at least one coating agent.

13. The Endodontic instrument of claim 12 wherein said covalently bonded anti-microbial compound comprises quaternary ammonium cations.

14. The dental instrument of claim 12 wherein said quartenary ammonium cations comprises N-alkyl-pyridinium, poly(4-vinyl-N-alkylpyridinium), N-alkylated-Polyethylenimine, or mixtures thereof.

15. The dental instrument of claim 12 wherein said anti-microbial compound comprises an alkyl side chain length of about 0 to about 12 carbons.

16. The dental instrument of claim 12 wherein said anti-microbial compound comprises an alkyl side chain length of from about 5 to about 7 carbons.

17. The dental instrument of claim 12 wherein said metal ions comprise transition metal ions.

18. The dental instrument of claim 12 wherein said source of metal ions comprises an ion exchange resin containing a metal ion source.

19. The dental instrument of claim 18 wherein said metal ions comprises silver, zinc, copper, iron or mixtures thereof.

20. The dental instrument of claim 18 wherein said transition metal ion source comprises a zirconium phosphate-based ceramic ion exchange resin containing silver.

21. A dental instrument comprising a substrate for forming at least a portion of said dental instrument, wherein said substrate comprises at least one source of metal ions for inhibiting or retarding the growth of microbes on said at least a portion of said instrument.

22. The dental instrument of claim 21 wherein said source of metal ions comprises an ion exchange resin containing a metal ion source.

23. The dental instrument of claim 21 wherein said metal ions comprises silver, zinc, copper, iron or mixtures thereof.

24. The dental instrument of claim 21 wherein said metal ion source comprises a zirconium phosphate-based ceramic ion exchange resin containing silver.

25. The dental instrument of claim 21 wherein said source of metal ions is embedded or dispersed in the substrate.

26. The dental instrument of claim 21 wherein said portion of the instrument comprises a working portion, a non-working portion, or combinations thereof.

27. The dental instrument of claim 26 wherein said portion further comprises an anti-microbial coating covalently bonded to a surface of the instrument.
